(19) United States
(12) Patent Application Publication
(10) Pub. No.: US 2004/0155374 A1
(43) Pub. Date: Aug. 12, 2004

(54) Method and apparatus for recycling R-PET and product produced thereby

(76) Inventors: Peter Hutchinson, Culcheth (GB); Mark Royall, Liverpool (GB)

Correspondence Address: Charles N. Quinn, Esq., Fox Rothschild LLP, 10th Floor, 2000 Market Street, Philadelphia, PA, 19103, US

(21) Appl. No.: 10/739,586

(22) Filed: Dec. 17, 2003

Related U.S. Application Data
(60) Provisional application No. 60/434,719, filed on Dec. 18, 2002.

(51) Int. Cl. B29C 47/00

(52) U.S. Cl. 264/40.1; 264/349; 264/140; 428/35.7; 428/542.8; 264/918; 264/920; 425/208; 425/209; 425/308

(57) ABSTRACT

Preferred embodiments of the present invention comprise a method of manufacture utilizing significant amounts of R-PET and the preform and/or beverage bottle produced thereby. The method preferably comprises washing colored beverage bottles and substantially clear beverage bottles to remove any surface filth, forming colored R-PET flakes from the washed colored beverage bottles, and forming substantially clear R-PET flakes from the washed substantially clear beverage bottles. The colored R-PET flakes are preferably blended with the substantially clear R-PET flakes to form blended flakes having substantially homogenous color. The blended flakes are color corrected if so desired, and the blended flakes are then pelletized. The pelletized flakes are preferably combined with V-PET to form a preform which is then preferably shaped into a beverage bottle.

### CROSS-REFERENCE TO RELATED APPLICATIONS

The present application claims the benefit under 35 U.S.C. § 119(e) of U.S. Provisional Application No. 60/434,719 filed Dec. 18, 2002, which is hereby incorporated by reference in its entirety for all purposes.

### BACKGROUND OF THE INVENTION

The invention relates generally to a method and apparatus for recycling PET resin and the product produced thereby. The invention further relates to a process, whereby flakes are strategically blended and combined with substantially virgin PET resin to form preforms and/or bottles.

As used herein, the abbreviation “PET” denotes polyethylene terephthalate, and the abbreviation “V-PET” denotes substantially virgin PET resin. As used herein the abbreviation “R-PET” denotes recycled PET, such as PET already contained within an after-market beverage bottle or other after-market product. R-PET preferably comprises post-consumer recycled (PCR) PET and/or another type of recycled PET. As used herein, a “preform” is an object that has been subjected to preliminary processes. Depending upon the embodiment, the preform may or may not be the subject of further processing (e.g. such as shaping the preform into a beverage bottle).

PCR is recycled material, such as from previously used soft drink bottles, which has been recycled by being ground into small pellets and sold back to a bottle manufacturer for addition, at a rate on the order of ten percent (10%) by weight, into new injection molded, blow molded or extruded products such as soft drink bottles. The modern soft drink bottle is typically manufactured of the well-known thermopolymer PET. In the course of manufacture of the bottle, a number of other materials need to be provided as additives to the PET in order to blow-mold a satisfactory soft drink bottle. In present practice, the resin supplier frequently adds additive materials to V-PET resin during compounding and prior to the blow-molding process. As a result, V-PET supplied to a bottle manufacturer has required additives already blended into the V-PET.

As environmental pressures and concerns mount, manufacturers of soft drink bottles, soft drink manufacturers and beverage distributors are requiring that soft drink bottles, which previously have been made of V-PET, contain more and more PCR material, when the bottled beverages are sold. Where environmental regulations and other concerns require a bottle manufacturer to use PCR, usage of PCR having additives already included therein provides lower cost raw material than when all of the separate required additive items are brought and introduced separately into the blend to be processed into bottles.

It is known in the art to collect beverage bottles for recycling. These beverage bottles are sorted into groups of colored and clear bottles. The colored bottles are typically either sold for strapping or fiber or are scrapped. Use of PCR is more expensive than use of V-PET material together with customary required additives. However, as environmental concerns and economic pressures grow, major beverage manufacturers are requiring that PCR be included as a major component in the bottles the beverage companies purchase to fill with their beverage products for subsequent sale. Unlike the waste of substantially clear bottle waste, after-market colored bottles have not previously been able to be recycled in significant quantities by the bottling industry. This has resulted in after-market colored bottles being of low value and primarily being scrapped for landfills, being exported with the resulting environmental cost of the transport, or being used in lower value, lower volume applications such as strapping.

Preform manufacturers currently use R-PET as the “sandwich” layer between outer layers of V-PET. This approach requires significant capital investment, typically in co-extrusion equipment capable of producing such containers. This multi-layer, sandwich approach is also technically complex and reduces process efficiency. R-PET is also sometimes used by bottle and other blow-molded product preform manufacturers to blend R-PET with V-PET. This requires capital expenditure for R-PET dosing equipment and separate facilities for storage, handling and drying of the R-PET material prior to the blending. It also requires that such preform manufacturers have necessary resin blending and resin coloring equipment, and that the preform manufacturers maintain inventories of resin color materials and other required additives if the resulting blend of R-PET resin is to be colored or otherwise modified.

Some bottle and other blow-molded preform manufacturers buy their resin in grades, which are a blend of V-PET and R-PET. In such case, the purchased resin is usually uncolored. As a consequence, additional blending and other equipment is required and maintenance of an inventory of additives is necessary if the preform manufacturer intends to modify the color or performance of the preform.

All of these methods have disadvantages. All of them require that the R-PET first have been sorted to remove colored material before the R-PET is recovered for re-use. None of these methods address the fact that a large quantity of the PET waste collected each year for recycling is colored material. The PCR may, if transparent, be re-used in low value applications such as for strapping or as fiber, but the transparent PCR is just as often be scrapped due to its low value.

With current recycling practice, bottles are first passed through an x-ray device which removes bottles either made from PVC or which use PVC labels. The remaining bottles, after passing through the x-ray detector, are ground into flake-like material. The flake material is then put through flotation tanks in which the density difference between PET and polyethylene works to remove things such as closures and labels from the material. The material is next hot washed in a caustic solution to remove the majority of contaminant before the material is extruded on a vented extruder and strand or die-face cut into a pellet form. This pelletization removes any remaining contaminants and produces an amorphous grade chip suitable for the production of PET bottles. The chip may be subjected to a solid-state process if a higher molecular weight and/or crystallinity content is required.

PET is also recovered by chemical means in which a PET bottle is treated in order to break it down into constituent parts such as ethylene glycol, which may then either be used to produce V-PET or be used for other applications such as anti-freeze. Known mechanical means of recycling PET use similar technologies; to date, only mechanical recycling of PET bottles has proven commercially viable.

One current method of PET coloration/modification involves use of “master batches” which are high concentrations of pigment or dye colorants in a PET carrier. These master batches are typically supplied for addition to the PET at rates of between 0.5-3.0% by weight. These low addition rates make the incorporation or the accuracy of the feeding of the master batch into the PET a problem. The low addition rates required when using a master batch also make it difficult to achieve even distribution and dispersion of the master batch material in the PET; this a problem in that the finished molded product will not exhibit uniform coloring since the distribution and dispersion of the master batch material in the PET resin is uneven.

Another current method of PET coloration/modification involves use of liquid concentrates, such as high concentrations of pigment or dye colorants in a liquid carrier system. Techniques for dosing PET with liquid color concentrates are accurate but can be messy since tubes and pipes may be involved in transporting the liquid concentrate. Valves and fittings, which are necessarily a part of the liquid color concentrate transport system, may leak. Any such leakage with consequent resulting violation of sanitary regulations can be unacceptable in a facility manufacturing preforms, such as those preforms to be used for blow-molding beverage bottles, for example. Additionally, stability and shelf-life of liquid color concentrates is sometimes of concern as are possible effects of the liquid color concentrate on the processing of the PET to which the concentrate is to be added.

Dosing liquid colorants to the PET at addition rates high enough to produce opaque colored products can also cause problems with processing. PET coloration/modification during manufacture of the resin or by subsequent re-compounding is uneconomic, limits the range of colors available and causes contamination and handling issues for the PET converter. Furthermore, rising environmental concerns and the economies of scale demand a better way of producing bottles with PET.

The invention disclosed herein addresses the above-identified deficiencies and other deficiencies in the prior art.

### SUMMARY OF THE INVENTION

Preferred embodiments of the invention relate to a method of manufacture utilizing significant amounts of R-PET. After-market products are collected that have R-PET as a substantial component thereof. The after-market products are preferably recylcled beverage bottles, including colored beverage bottles and substantially clear beverage bottles. In some aspects, the colored beverage bottles are green-colored beverage bottles. The colored beverage bottles are preferably washed to remove any surface filth and are formed into colored R-PET flakes. Also, the substantially clear beverage bottles are preferably washed to remove any surface filth and are formed into substantially clear R-PET flakes.

The method preferably includes blending the colored R-PET flakes with the substantially clear R-PET flakes to form blended flakes, which preferably have a substantially homogeneous color and are about seventy-percent (70%) by weight colored R-PET flakes. As described herein, some embodiments of the method only require colored R-PET flakes, the remainder of the blend being comprised of other additives. In the preferred embodiment, it is then determined whether the blended flakes have the desired color, and if the blended flakes do not have the desired color, the blended flakes are color-corrected with pure color.

The method preferably includes pelletizing the blended flakes and combining the pelletized flakes with V-PET to form a preform. In some aspects, the preform is preferably at least about ten percent (10%) by weight pelletized flakes, preferably being about twenty percent (20%) by weight pelletized flakes. In some aspects, the preform is further processed, such as by shaping the preform into a beverage bottle.

The pelletized flakes, also referred herein as color concentrate, possess excellent dispersion characteristics, and are a high addition rate colorant. Preforms produced in accordance with preferred embodiments also demonstrate excellent color distribution, both within a single preform, as well as from one preform to another preform.

The pelletized flakes are also environment-friendly, being formed at least in part by R-PET. A further major benefit of the pelletized flakes is that they are formed from colored bottle waste (green bottle waste, etc.), which is a byproduct of the bottling industry.

### BRIEF DESCRIPTION OF THE DRAWINGS

The accompanying drawings, which are incorporated into and form a part of the specification, illustrate the embodiments of the present invention and, together with the description serve to explain the principles of the invention. In the drawings:

FIG. 1 is a flow chart showing a preferred embodiment of a method of manufacture utilizing significant amounts of R-PET;

FIG. 2 is a side view drawing showing an embodiment of an extruder;

FIG. 3 is an isometric view drawing showing an embodiment of a dryer;

FIG. 4 is a hybrid view (side view and isometric view) drawing showing an embodiment of a molding press; and

FIG. 5 is a side view drawing showing an embodiment of a weigh-scale blender.

### DESCRIPTION OF THE PREFERRED EMBODIMENTS AND BEST MODE KNOWN FOR PRACTICING THE INVENTION

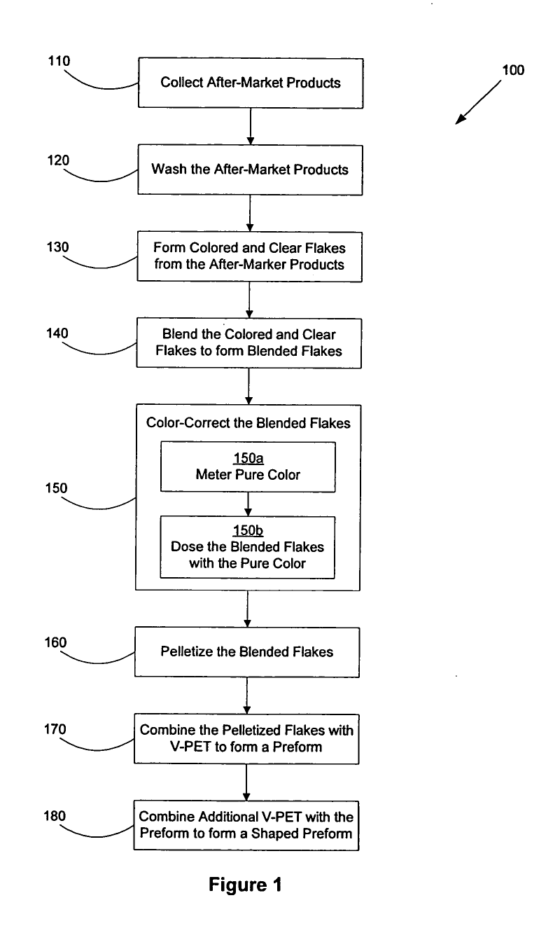

Full production trials on production scale equipment were conducted, confirming that the blended flakes manufactured from colored after-market products (e.g. colored beverage bottles) have good application in a production environment. With principal reference to FIG. 1, a preferred method of manufacture utilizing significant amounts of R-PET, designated generally 100, will now be discussed in detail. Discussion of the above-mentioned production trials is also included below.

At collecting step 110, after-market products are preferably collected, the after-market products including any suitable products that contain significant amounts of PET to be recycled as R-PET. The after-market products are preferably after-market beverage bottles containing significant amounts of PET. Collecting step 110 is preferably implemented by any suitable means known in the art, including as a nonlimiting example, collecting beverage bottles from recycling redemption center and/or machines where consumers have deposited the after-market products. In some aspects, the collected after-market products are separated by any suitable means known in the art, such as separation of beverage bottles from beverage cans, separation of plastic from glass, separation of colored beverage bottles from substantially clear beverage bottles, etc.

At washing step 120, the recycled beverage bottles or other after-market products containing significant amounts of R-PET are preferably washed. Washing step 120 preferably occurs prior to flaking step 130. In preferred embodiments, colored after-market products (e.g. green-colored beverage bottles containing R-PET) are washed so as to remove any surface filth. Washing step 120 preferably utilizes hot-washing the beverage bottles with a contaminant-rinsing caustic solution, however washing step 120 can utilize any suitable means known in the art.

At flaking step 130, R-PET flakes are formed from the washed after-market products. Flaking step 130 preferably utilizes chemical recovery and/or mechanical flaking with a shredder, however flaking step 130 can utilize any suitable means known in the art. In some aspects, forming of the R-PET flakes at flaking step 130 is preferably conducted in a manner to ensure that each batch of flakes is made from similarly-colored after-market products. By way of nonlimiting example, colored after-market products, e.g. green beverage bottles, are preferably formed into colored R-PET flakes, while any substantially clear after-market products, e.g. substantially clear beverage bottles, are preferably formed into substantially clear R-PET flakes. Importantly however, some embodiments of the present invention anticipate some degree of comingling between colored beverage bottles and substantially clear beverage bottles, and these embodiments are further discussed below with reference to the blending step 140.

Continuing with principal reference to FIG. 1, at blending step 140 the colored R-PET flakes are preferably blended with the substantially clear PET flakes to form blended flakes. An integrated machine is preferably used to implement both blending step 140 and pelletizing step 160, however any suitable means known in the art can be used to blend the colored R-PET flakes and substantially clear PET flakes. The preferred integrated machine includes a vented single-screw Sterling extruder with a Gala die-face cut pelletizer and a cyclone dryer. More specifically, the dryer is preferably a two desiccant bed ConAir dryer having a 10,000 lb capacity, with temperature set at +160 degrees Celsius and dew point set to −40 degrees Celsius.

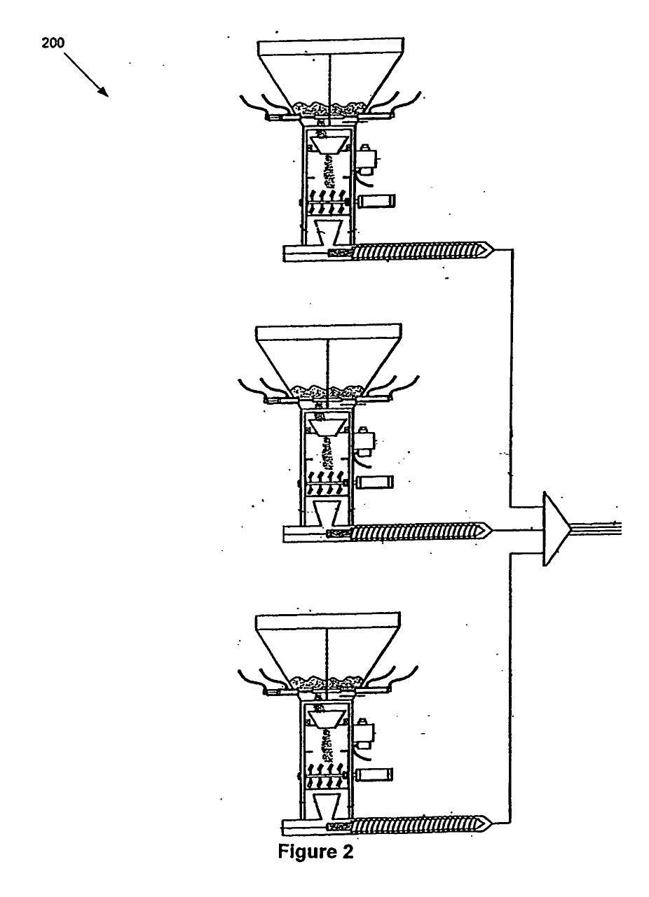

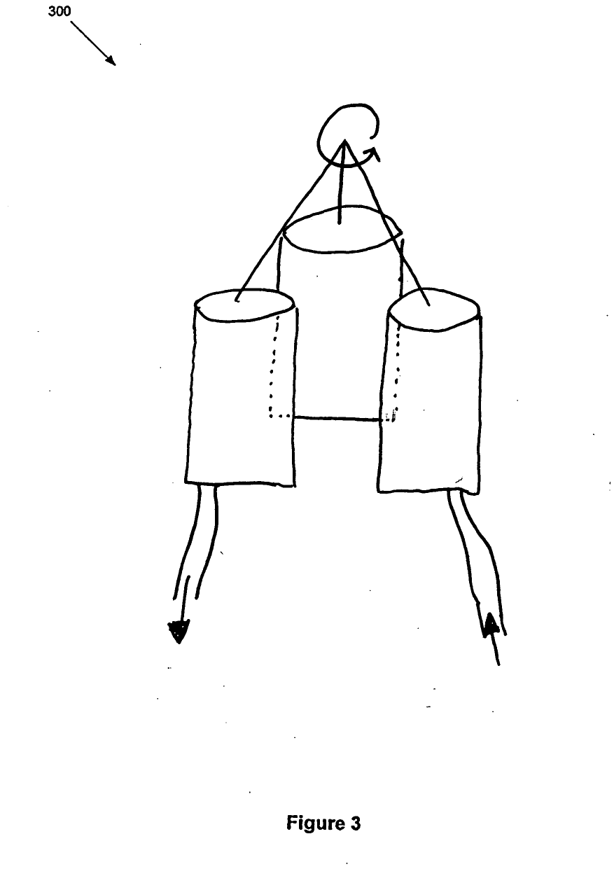

Blending step 140 (and pelletizing step 160) are implementable with any of a great majority of the extrusion and pelletizing equipment currently in use in the recycling industry, however it is preferred that the equipment include twin screw extruders having both co- and contra-rotation, ring extruders and strand-cut pelletizing. A sample extruder is shown in FIG. 2 and designated generally 200, while a sample dryer is shown in FIG. 3 and designated generally 300. Sample extruder 200 is one typical of those used in the art and is easily adaptable to implement embodiments of the present invention. The sample dryer is preferably a Maguire Products, Inc. low pressure dryer, described in U.S. Pat. No. 6,154,980 (“'980 patent”), and available from Maguire Products, Inc. in Aston, Pa.

Blending step 140 will now discussed in further detail. Colored R-PET flakes and substantially clear flakes are preferably blended at a 7:3 blend ratio, which is approximately the same proportion of colored beverage bottles (e.g. green beverage bottles) to substantially clear beverage bottles as is typically found in most regions where the use of colorants is not restricted or prohibited. The use of this proportion minimizes any necessity to sort the beverage bottles into a set of colored beverage bottles and a set of substantially clear beverage bottles.

While the 7:3 blend ratio is generally preferred for green coloring, the desired blend ratio for a specific application can vary depending on the nature of what is included in the blended flakes. For example, while it is preferred that the blended flakes be made from colored R-PET flakes and substantially clear PET flakes, the blended flakes can also be made to include V-PET, off-spec and/or post-industrial resin (PIR), etc. Moreover, in some aspects, the substantially clear PET flakes comprise PET flakes other than R-PET flakes. Such other materials are included for numerous reasons including, as a nonlimiting example, to compensate for material shortages and/or cost concerns. The 7:3 blend ratio can be altered to account for the inclusion of such other materials

Continuing with principal reference to FIG. 1, it is determined at color-correcting step 150 whether color-correction of the blended flakes is desired. As discussed further below, the step of “color-correction” is not just for correcting errors. Color-correcting step 150 is useful for customizing color, correcting any error in the color, and changing the color for other reasons.

If color-correction is desired, then the blended flakes are color-corrected preferably with pure color. Liquid color is the preferred type of pure color due to its lack of a prior thermal history, the ability of the liquid color to be accurately dosed into the blended flakes for color-correction, and the excellent dispersability of liquid color. However, other suitable types of pure color can also be used, such as a solid colorant (e.g. masterbatches). Both solid colorants and liquid colorants comprise raw dyes and/or pigment powders, which are are dispersable in liquid and solid phases.

Color-correcting step 150 comprises metering step 150a, wherein an amount to be dosed into the blended flakes is determined, and dosing step 150b, wherein the blended flakes are dosed with the measured amount of pure color.

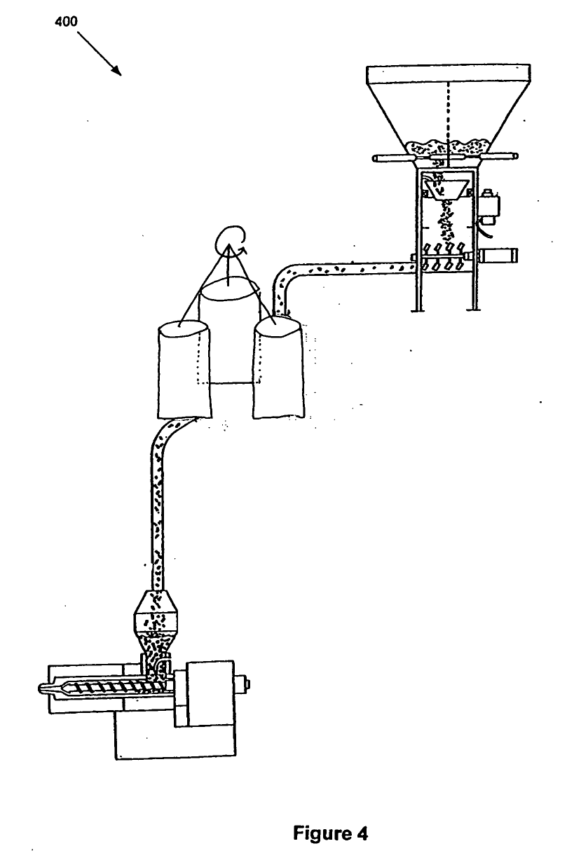

Metering step 150a is preferably implemented by taking a measured amount of the blended flakes and injection molding a preform. Preferable means for injection molding include a 15 ton Boy injection molder. A sample molding press is shown in FIG. 4, designated generally 400, is typical of the molding presses known in the art and is easily adapted to be suitable for implementing embodiments of the present invention. Pure color is added to a sample of the blended flakes until the desired color is achieved, and the dispensed amount of pure color is compared to the measure of blended flakes to measure the appropriate amount of pure color for subsequent dosing. The dispensed amount of pure color is preferably measured with a metering unit, such as a peristaltic pump and constant rate controller unit adapted to feed the pure color into the feed-throat of the molding press at a known rate. After the amount of pure color is determined, it can be confirmed by dosing a sample of blended flakes and comparing the weight of the sample to the time it took to dose the sample.

For the color green, for example, liquid color is in “typical commercial use” for at three different addition rates, 0.050%, 0.060% and 0.070%, each corresponding to the three common depths of green. During the production trials, however, addition rates of 0.045%, 0.055% and 0.060% were found to be best. As discussed in further detail below regarding combining step 170, the dosed blended flakes are to be subsequently pelletized and combined with V-PET at a 4:1 combination ratio. Because the dosed blended flakes only preferably comprise 20% of the 4:1 combination, the addition rates are adjusted by a factor of five (5) to achieve higher addition rates (e.g. 0.225%). This combination and the 4:1 combination ratio will be discussed below in further detail with regards to combination step 170. Color-correcting step 150 comprises metering step 150a, wherein an amount to be dosed into the blended flakes is determined, and dosing step 150b, wherein the blended flakes are preferably dosed with the pure color.

During the production trials, this desired addition rate has been substantially accounted for in arriving at the 7:3 blend ratio. This has the advantage of minimizing the necessity of color-correction step 150 and in many cases, completely eliminating the need to color-correct the blended flakes. This significantly simplifies the manufacturing process. Thus, liquid color need only be added in certain desired situations. In some cases color-correction may be desired, such as for example (1) when a consumer requires a custom color shade, (2) when the blended flakes were created from a co-mingled batch of green beverage bottles and substantially clear beverage bottles that did not have the statistically predicted blend ratio, (3) when an error or an anomaly is present, or (4) other reasons. As discussed below regarding dosing step 150b, however, color correction is preferably utilized to customize the depth of the color.

At dosing step 150b the addition rate of the pure color determined at metering step 150a is programmed into a metering system to dose the blended flakes with pure color in an extruder. The feed tube is preferably left disconnected to the extruder. The pure color is preferably fed into the feedthroat of the extruder, however it is also contemplated that dosing can occur further downstream at the extruder vent, thereby reducing and/or eliminating any problems caused by screw slip. Dosing step 150b is preferably monitored, allowing quick identification if the addition rate should be changed throughout dosing step 150b. After dosing with the extruder, it is preferable that the extruder be allowed to settle down prior to the extruder being turned off.

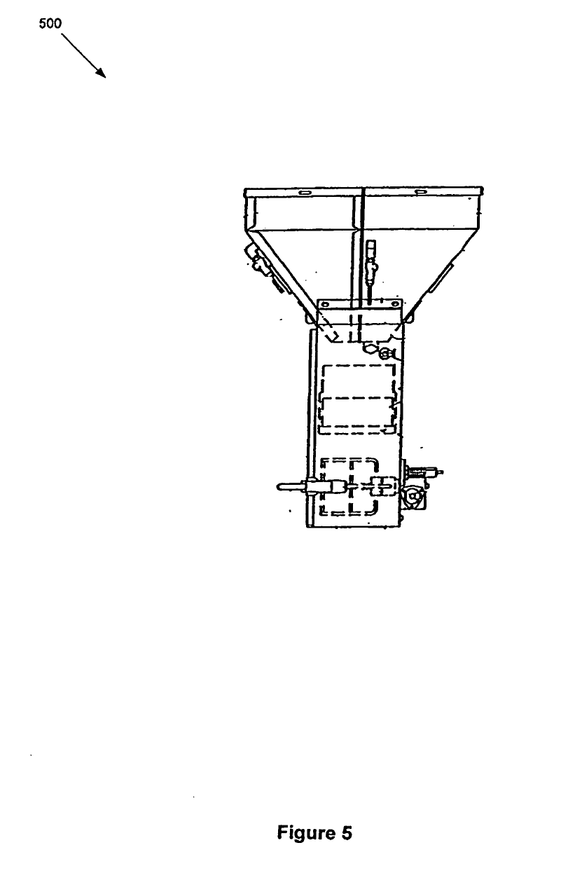

In some embodiments of metering step 150a and dosing step 150, it is preferred that the pure color be metered and dosed using a weigh scale blender with a diaphragm pump, which is used to weigh a known amount of blended flakes and dose an appropriate amount of pure color onto the blended flakes. A sample weigh scale blender is shown in FIG. 5 and designated generally 500. Weigh scale blender 500 as shown is preferably the Maguire Products, Inc. weigh scale blender disclosed in U.S. Pat. No. 6,402,363 (“'363 patent”), the contents of which are herein incorporated by reference for all purposes. Although, the weigh scale blender disclosed in the '363 patent is preferred, any suitable weigh scale blender can be utilized.

Continuing with principal discussion of dosing step 150b, it is not unlikely that consumer may require custom coloring, or more specifically, custom color depth. For example, while many manufacturers utilize the same shade of green, the depth of the desired color is different in different market regions. Although, this can be accounted for under some circumstances in choosing the parameters of the blend ratio, this can also be accomplished at color-correction step 150. Three (3) production trials were undertaken, one for each of the three addition rates (multiplied by a factor of 5). The results of these production trials are shown in Table 1, Table 2 and Table 3, and show that the 7:3 blend ratio of green flakes to substantially clear flakes is easily modifiable to common depths of green.

In each of the three production trials, four (4) 500 pound samples were taken. In the first production trial, the addition rate was substantially equivalent to a beverage bottle manufactured with V-PET at a depth equivalent of 0.050% of the control pure color (Table 1); in the second production trial, the addition rate was substantially equivalent to a beverage bottle manufactured with V-PET at a depth equivalent of 0.060% of the control pure color (Table 2); and in the third production trial, the addition rate was substantially equivalent to a beverage bottle manufactured with V-PET at a depth equivalent of 0.070% of the control pure color (Table 3).

As used in Table 1, Table 2 and Table 3, L* refers to the light/dark value of a color in 3-D color space, where the higher L* values refer to lighter colors. a* refers to the green value/red value, where a negative a* value refers to greener depth and a positive a* value refers to redder depth. b* refers to the blue/yellow value, where a negative b* value refers a bluer depth and a positive b* value refers to a yellower depth. DE refers to the overall color difference of the batch against the reference standard.

TABLE 1
0.225% Addition Rate

| | Change in | Control Difference | Average |
|---|---|---|---|
| | Depth | (0.050% Control) | Deviation |
| L* | +45.24 | 0.82 | 0.12 |
| a* | −37.38 | 0.13 | 0.04 |
| b* | 52.01 | 0.55 | 0.10 |
| DE | — | 0.56 | 0.11 |

TABLE 2
0.275% Addition Rate

| | Change in | Control Difference | Average |
|---|---|---|---|
| | Depth | (0.060% Control) | Deviation |
| L* | 41.04 | 0.95 | 0.16 |
| a* | −39.21 | 0.28 | 0.06 |
| b* | 54.44 | 0.72 | 0.07 |
| DE | — | 0.77 | 0.07 |

TABLE 3
0.300% Addition Rate

| | Change in | Control Difference | Average |
|---|---|---|---|
| | Depth | (0.070% Control) | Deviation |
| L* | 38.60 | 0.17 | 0.05 |
| a* | −42.00 | 0.34 | 0.09 |
| b* | 55.91 | 0.37 | 0.11 |
| DE | — | 0.25 | 0.07 |

During these three production trials, the extruder was allowed to settle down with the pure color switch on. Barrel temperatures, screw speed, screw torque and die-head pressure values were monitored to determine the effects of the colorant on the process and to when the process had stabilized. Stabilization occurred about 20 minutes after production. The preferred process conditions are articulated in Table 4.

TABLE 4

| | |
|---|---|
| Zone 1 Temp.: | 275 degrees Celsius |
| Zone 2 Temp.: | 275 degrees Celsius |
| Zone 3 Temp.: | 275 degrees Celsius |
| Zone 4 Temp.: | 275 degrees Celsius |
| Zone 5 Temp.: | 275 degrees Celsius |
| Die-Head Pressure: | 320-380 psi |
| Screw Speed: | 60 rpm |
| Screw Torque: | 55% |
| Output: | 2160 lbs/hr |

Continuing with principal reference to FIG. 1, at pelletizing step 160 the blended flakes are pelletized. Pelletizing step 160 occurs regardless of whether metering step 150a and dosing step 150b were implemented or not implemented. Any suitable means for pelletizing the flakes is appropriate. As nonlimiting examples, the blended flakes can be fed to a crystallizer and/or uprated by solid state processing. The preferred intrinsic viscosity of the pelletized flakes is about 0.82 dl/g.

At combination step 170, the pelletized flakes are preferably combined with V-PET to form a preform at a 4:1 combination ratio; the preform thus preferably being about 20% by weight pelletized flakes. In contrast to the addition rates of traditional color concentrates at 0.5-3.00%, the larger 20% addition rate allows for increased control over the combination of the (colored) pelletized flakes with the V-PET. The 4:1 combination ratio was obtained to achieve a final color that would resemble the color of the some of the most commercially successful green beverage bottles currently available. The depth of the final color can be varied according to taste and market concerns by altering the 4:1 combination ratio accordingly. However, it is preferred that the preform be at least about 10% by weight pelletized flakes.

During the production trials, three (3) trials were conducted comparing the uses of control R-PET, blended flakes pelletized by crystallization, and blended flakes pelletized by solid-state processing. Table 5 shows the value of these characteristics for each of the three (3) preforms resulting from these three (3) trials. The results in Table 5 show that the implementation of embodiments of the invention do not have an undue effect upon the physical nature of the preform.

TABLE 5

| | Control | Pelletized Flakes | Pelletized Flakes |
|---|---|---|---|
| | R-PET | (Crystallization) | (Solid-State Processing) |
| Intrinsic | 0.737 | 0.740 | 0.823 |
| Viscosity (dl/g) | | | |
| Acetaldehyde | 0.53 | 0.41 | 0.43 |
| Level (ppm) | | | |
| Melt Point | 246.5 | 246.1 | 246.2 |
| (Degrees | | | |
| Celsius) | | | |
| DSC | 52 | 55 | 54 |
| Crystallinity (%) | | | |

Continuing with principal discussion of combination step 170, injection molding and/or extruding is preferably utilized to combine the pelletized flakes and V-PET. Preferred injection molding machines include the Husky 300XL, with 48 cavities processing at a cycle time of 15 seconds. This machine is typical of that used in the PET conversion industry. Another preferred injection molding machine includes the Husky 600 Index, with 96 cavities per face processing at 11.1 second cycle time. This is representative of the newer, higher volume machines being used in the industry.

Production trials were conducted on the Husky 300XL, and as the state of the art progresses, any suitable injection-molding machine can be utilized. These two sample injection molding machines, often known as two stage (or two-step) equipment, are often part of a process wherein the sample injection molding machine produces the preform, but a second machine is required to blow the preform into a shaped preform after the preform is conditioned (by cooling and storage for about at least twenty-four 24 hours). However, in some embodiments, combination step 170 and forming step 180 can be performed on a single machine. The three (3) production trials of Table 5 were conducted on the Husky 300XL, 48 cavity processing at a cycle time of 15 seconds, with a preform weight of 24.7 g, which was set with the values articulated in Table 6.

TABLE 6

| | |
|---|---|
| Cycle time: | 16.1 seconds |
| Barrel temperatures | |
| Feedthroat: | 255 degrees Celsius |
| Zone 1 | 265 degrees Celsius |
| Zone 2 | 275 degrees Celsius |
| Zone 3 | 275 degrees Celsius |
| Zone 4 | 275 degrees Celsius |
| Shooting Pot: | 275 degrees Celsius |
| Nozzle | 275 degrees Celsius |
| Manifold | 275 degrees Celsius |
| Hot runner | 270 degrees Celsius |

Continuing with principal discussion of combination step 170, it is important that the pelletized flakes be introduced to the V-PET at the correct 4:1 combination ratio. There are at least three ways, logistically speaking, in which the pelletized flakes can be introduced to the V-PET. Theses three ways are listed below as nonlimiting examples and other ways are contemplated. Each of the three ways are associated with different logistics-related issues that have bearing on the type of equipment used at combination step 170 to make the 4:1 combination.

First, a “salt & pepper” blend of pelletized flakes and V-PET can be supplied to a preform manufacturer. However, this requires that the supplier have blending equipment, such as for example, a ribbon blender or other similar large-scale continuous and/or batch blending equipment. Blending large quantities on a site remote to the preform manufacturer is logistically problematic. It is also problematic in that the supplier would require a silo and a dryer.

Second, the preform manufacturer itself produces on site a “salt & pepper” blend of the pelletized flakes and V-PET. Because smaller volumes of preform would be manufactured than at the upstream supplier, manufacturer blending would most likely only require a weigh scale blender or similar device. On-site blending is disadvantageous, however, in that it requires monitoring and/or intervention of the preform manufacturer. This opens up combination step 170 to a higher likelihood of human error in the implementation.

Third, the preform manufacturer could meter the amount of pelletized flakes during the injection cycle into the feed throat of the injection molding machine. After setting the rate of metering, no further intervention is required by the preform manufacturer at combination step 170. This third approach allows the preform manufacturer the freedom to vary the 4:1 combination ratio as desired. It also allows the manufacturer to order pelletized flakes from a first supplier and order V-PET from a second supplier. In some aspects, this is the preferred approach of the three for dealing with the logistics of combining the pelletized flakes and V-PET

In addition to an injection molding machine, combination step 170 preferably comprises a weigh scale blender, a main dryer and a secondary dryer. The weigh scale blender preferably has two in-feed ports, one of which takes a known weight of V-PET from the main dryer and the other which takes a known weight of pelletized flakes from the secondary dryer. The weigh scale blender blends the pelletized flakes with the V-PET at the appropriate ratio before feeding them to the injection molder, the appropriate ratio being the 4:1 combination ratio, a customized 4:1 combination ratio, etc.

The secondary dryer is preferably the dryer of the '980 patent utilizing the principle that air at lower pressures holds less moisture than air at standard conditions. The pelletized flakes are first heated in a chamber to 150 degrees Celsius, and then passed to a second chamber having reduced vacuum, the lower pressure of the reduced vacuum thereby removing moisture. The pelletized flakes are then passed to a third chamber where temperature is held at a constant 150 degrees Celsius until the pelletized flakes are required. Use of the Maguire Products, Inc. low pressure dryer as the secondary dryer facilitates drying of the pelletized flakes in about 45-60 minutes. By contrast, a conventional desiccant bed dryer requires temperature of 150-180 degrees Celsius and a drying time of 4-6 hours. Other benefits of using the Maguire Products, Inc. dryer as the secondary dryer include, for example, (1) reduced energy consumption and (2) a reduction in the level of polymer degradation and IV build resulting from higher temperatures.

At forming step 180, the preform is shaped into a shaped preform, preferably using a blower, such as an SBO24, or other suitable shaping machine known in the art. In some aspects, the shaped preform is a second preform or other shape, however the shaped preform preferably comprises a beverage bottle. In the production trials discussed in Table 2, blowing the preform into bottles was conducted at a blowing output of 22,00 bottles per hour, and using a reheat temperature of 105 degrees Celsius. Inspection of the beverage bottles during the production trials revealed that that the beverage bottles were of excellent visual quality and that streaking and poor color distribution was noticeably absent.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

As nonlimiting examples, the present invention can be applied to a host of applications and industries, such as blue water bottles packaging, opaque and specialty colors such as pearlescents, additives such as resin color modifiers/toners, UV absorbers and blockers, taint and odour modifiers including acetaldehyde reducers, barrier additives to reduce CO₂ loss and O₂ ingress, dimensional stabilizers, nucleating agents, reheat additives, viscosity modifiers and additives intended to increase the performance of refillable bottles. Furthermore, R-PET can be used as a carrier for colorants and/or additives for polyesters used for textile application and for polyester strapping. Also, PCR, PIR and polyethylene naphthalate (PEN, a resin used usually as a blend with PET for refillable bottles) as a carrier system either on its own or as a blend with PET for colorants and additives intended for refillable bottles, containers and related applications.

What is claimed is:

1. A method of manufacturing a color concentrate utilizing significant amounts of R-PET, comprising:
blending colored R-PET flakes with substantially clear PET flakes to form blended flakes having substantially homogenous color;
determining whether color correction of the blended flakes is desired, and if color correction is desired, color-correcting the blended flakes with pure color; and
pelletizing the blended flakes.

2. The method of claim 1, wherein blending comprises blending colored R-PET flakes with substantially clear R-PET flakes to form the blended flakes.

3. The method of claim 1, wherein blending comprises blending colored R-PET flakes with substantially clear R-PET flakes and post-industrial resin to form the blended flakes.

4. The method of claim 1, wherein blending comprises blending colored R-PET flakes with substantially clear PET flakes to form the blended flakes, the blended flakes being about seventy-percent (70%) by weight the colored R-PET flakes.

5. The method of claim 1, comprising calculating a blend ratio of colored R-PET flakes to substantially clear PET flakes, in accordance with a desired combination ratio of blended flakes to V-PET.

6. The method of claim 1, comprising:
washing colored after-market products to remove any surface filth;
forming the colored R-PET flakes from the washed colored after-market products;
washing substantially clear after-market products to remove any surface filth; and
forming the substantially clear PET flakes from the washed substantially clear after-market products.

7. The method of claim 6, wherein washing colored after-market products comprises washing colored beverage bottles, and wherein washing substantially clear after-market products comprises washing substantially clear beverage bottles.

8. The method of claim 1, wherein determining comprises determining whether a color depth correction of the blended flakes is desired, and if color depth correction is desired, color-correcting the color depth of the blended flakes with pure color.

9. A method of manufacturing a preform utilizing significant amounts of R-PET, comprising:
blending colored R-PET flakes with substantially clear PET flakes to form blended flakes having substantially homogenous color;
determining whether color correction of the blended flakes is desired, and if color correction is desired, color-correcting the blended flakes with pure color;
pelletizing the blended flakes; and
combining the pelletized blended flakes with V-PET to form the perform, the preform being at least about ten percent (10%) by weight pelletized flakes.

10. The method of claim 9, wherein blending comprises blending colored R-PET flakes with substantially clear R-PET flakes to form the blended flakes.

11. The method of claim 9, wherein blending comprises blending colored R-PET flakes with substantially clear R-PET flakes and post-industrial resin to form the blended flakes.

12. The method of claim 9, wherein blending comprises blending colored R-PET flakes with substantially clear PET flakes to form the blended flakes, the blended flakes being about seventy-percent (70%) by weight the colored R-PET flakes.

13. The method of claim 9, comprising calculating a blend ratio of colored R-PET flakes to substantially clear PET flakes, in accordance with a desired combination ratio of blended flakes to V-PET.

14. The method of claim 9, comprising:
washing colored after-market products to remove any surface filth;
forming the colored R-PET flakes from the washed colored after-market products;
washing substantially clear after-market products to remove any surface filth; and
forming the substantially clear PET flakes from the washed substantially clear after-market products.

15. The method of claim 14, wherein washing colored after-market products comprises washing colored beverage bottles, and wherein washing substantially clear after-market products comprises washing substantially clear beverage bottles.

16. The method of claim 9, wherein determining comprises determining whether a color depth correction of the blended flakes is desired, and if color depth correction is desired, color-correcting the color depth of the blended flakes with pure color.

17. The method of claim 9, wherein combining comprises combining the pelletized blended flakes with V-PET to form the preform, the preform being about twenty percent (20%) by weight pelletized flakes.

18. The preform produced according to the method of claim 9.

19. A method of manufacturing a shaped preform utilizing significant amounts of R-PET, comprising:
blending colored R-PET flakes with substantially clear PET flakes to form blended flakes having substantially homogenous color;
determining whether color correction of the blended flakes is desired, and if color correction is desired, color-correcting the blended flakes with pure color;
pelletizing the blended flakes;
combining the pelletized blended flakes with V-PET to form the perform, the preform being at least about ten percent (10%) by weight pelletized flakes; and
shaping the preform into the shaped preform.

20. The method of claim 19, wherein blending comprises blending colored R-PET flakes with substantially clear R-PET flakes to form the blended flakes.

21. The method of claim 19, wherein blending comprises blending colored R-PET flakes with substantially clear R-PET flakes and post-industrial resin to form the blended flakes.

22. The method of claim 19, wherein blending comprises blending colored R-PET flakes with substantially clear PET flakes to form the blended flakes, the blended flakes being about seventy-percent (70%) by weight the colored R-PET flakes.

23. The method of claim 19, comprising calculating a blend ratio of colored R-PET flakes to substantially clear PET flakes, in accordance with a desired combination ratio of blended flakes to V-PET.

24. The method of claim 19, comprising:
washing colored after-market products to remove any surface filth;
forming the colored R-PET flakes from the washed colored after-market products;
washing substantially clear after-market products to remove any surface filth; and
forming the substantially clear PET flakes from the washed substantially clear after-market products.

25. The method of claim 24, wherein washing colored after-market products comprises washing colored beverage bottles, and wherein washing substantially clear after-market products comprises washing substantially clear beverage bottles.

26. The method of claim 19, wherein determining comprises determining whether a color depth correction of the blended flakes is desired, and if color depth correction is desired, color-correcting the color depth of the blended flakes with pure color.

27. The method of claim 19, wherein combining comprises combining the pelletized blended flakes with V-PET to form the preform, the preform being about twenty percent (20%) by weight pelletized flakes.

28. The shaped preform produced according to the method of claim 19.

29. The method of claim 19, wherein shaping comprises shaping the preform into a second preform.

30. The method of claim 19, wherein shaping comprises shaping the preform into a beverage bottle.

31. A method of manufacturing a color concentrate utilizing significant amounts of R-PET, comprising:
forming blended flakes from washed green beverage bottles having significant amounts of green R-PET flakes and from washed substantially clear beverage bottles having significant amounts of substantially R-PET flakes, the blended flakes being about seventy (70) percent green R-PET flakes by weight;
determining whether depth correction of the blended flakes is desired, and if depth correction is desired, color-correcting color depth of the blended flakes with pure color; and
pelletizing the blended flakes.

32. The method of claim 31, wherein color-correcting comprises color-correcting the color depth of the blended flakes at an addition rate equal to about five (5) times typical addition rates.

33. The method of claim 31, wherein color-correcting comprises color-correcting color depth of the blended flakes at an addition rate equal to at least one of about 0.225%, about 0.275% and about 0.300%.

34. A method of manufacturing a green preform utilizing significant amounts of R-PET, comprising:
forming blended flakes from washed green beverage bottles and washed substantially clear R-PET beverage bottles, the blended flakes being about seventy-percent (70%) by weight the green R-PET flakes;
determining whether a color depth correction of the blended flakes is desired, and if color depth correction is desired, color-correcting the color depth of the blended flakes with pure color;
pelletizing the blended flakes;
combining the pelletized blended flakes with V-PET to form the perform, the preform being at least about ten percent (10%) by weight pelletized flakes.

35. The method of claim 34, and wherein color-correcting comprises color-correcting the color depth of the blended flakes at an addition rate equal to about five (5) times typical addition rates.

36. The green preform produced according to the method of claim 35.

37. A method of manufacturing a green beverage bottle utilizing significant amounts of R-PET, comprising:
collecting green beverage bottles and substantially clear beverage bottles
washing the green beverage bottles and the substantially clear beverage bottles to remove any surface filth;
forming green R-PET flakes from the washed green beverage bottles and substantially clear R-PET flakes from the washed substantially clear beverage bottles;
blending green R-PET flakes with substantially clear R-PET flakes to form blended flakes having substantially homogenous green color, the blended flakes being about seventy-percent (70%) by weight the green R-PET flakes;
determining whether a color depth correction of the blended flakes is desired, and if color depth correction is desired, color-correcting the color depth of the blended flakes with pure color;
pelletizing the blended flakes;
combining the pelletized blended flakes with V-PET to form the perform, the preform being about twenty percent (20%) by weight pelletized flakes; and
shaping the preform into the green beverage bottle.

38. The green beverage bottle produced according to the method of claim 37.

39. A system for manufacturing a color concentrate utilizing significant amounts of R-PET, comprising:
a first extruder for blending colored R-PET flakes with substantially clear PET flakes to form blended flakes having substantially homogenous color;
a weigh scale blender for measuring pure color;
a pump for dosing the blended flakes with pure color; and
a pelletizer for pelletizing the blended flakes.

40. The system of claim 39, comprising a shredder for forming colored R-PET flakes from colored beverage bottles and for forming substantially clear R-PET flakes from substantially clear beverage bottles.

41. The system of claim 39, comprising a dryer for drying the pelletized flakes.

42. The system of claim 41, wherein the dryer comprises:
a first chamber for drying the pelletized flakes, thereby transferring pellet moisture to the chamber air;
a second chamber for vacuum evacuation of the moist chamber air; and
a third chamber for storing the pelletized flakes in a vacuum condition.

43. The system of claim 39, wherein the first extruder comprises a twin screw extruder having co- and contra-rotation, ring extruders

44. The system of claim 39, wherein the pelletizer comprises a strand-cut pelletizer.

45. The system of claim 39, wherein the first extruder and the pelletizer form an integrated machine.

46. The system of claim 45, wherein the first extruder comprises a twin screw extruder having co- and contra-rotation, ring extruders

47. The system of claim 45, wherein the pelletizer comprises a strand-cut pelletizer

48. The system of claim 39, wherein the pump comprises a peristaltic pump.

49. The system of claim 39, wherein the first extruder is adapted to blend the colored R-PET flakes with the substantially clear PET flakes to form the blended flakes, the blended flakes being about seventy-percent (70%) by weight the colored R-PET flakes.

50. The system of claim 39, wherein the pump doses the blended flakes with pure color to implement a color depth correction.

51. A system for manufacturing a preform utilizing significant amounts of R-PET, comprising:
a first extruder for blending colored R-PET flakes with substantially clear PET flakes to form blended flakes having substantially homogenous color;
a weigh scale blender for measuring pure color;
a pump for dosing the blended flakes with pure color;
a pelletizer for pelletizing the blended flakes; and
a second extruder for combining the pelletized blended flakes with V-PET to form the perform, the preform being at least about ten percent (10%) by weight pelletized flakes.

52. The system of claim 51, wherein the second extruder forms the preform, the preform being about twenty percent (20%) by weight palletized flakes.

53. The system of claim 52, the first extruder being adapted to blend the colored R-PET flakes with the substantially clear PET flakes to form the blended flakes, the blended flakes being about seventy-percent (70%) by weight the colored R-PET flakes.

54. The system of claim 51, comprising a shredder for forming colored R-PET flakes from colored beverage bottles and for forming substantially clear R-PET flakes from substantially clear beverage bottles.

55. The system of claim 51, comprising a dryer for drying the pelletized flakes.

56. The system of claim 55, wherein the dryer comprises:
a first chamber for drying the pelletized flakes, thereby transferring pellet moisture to the chamber air;
a second chamber for vacuum evacuation of the moist chamber air; and
a third chamber for storing the pelletized flakes in a vacuum condition.

57. The system of claim 51, wherein the first extruder comprises a twin screw extruder having co- and contra-rotation, ring extruders

58. The system of claim 51, wherein the pelletizer comprises a strand-cut pelletizer.

59. The system of claim 51, wherein the first extruder and the pelletizer form an integrated machine.

60. The system of claim 59, wherein the first extruder comprises a twin screw extruder having co- and contra-rotation, ring extruders

61. The system of claim 59, wherein the pelletizer comprises a strand-cut pelletizer

62. The system of claim 51, wherein the pump comprises a peristaltic pump.

63. The system of claim 51, wherein the pump doses the blended flakes with pure color to implement a color depth correction.

64. A system for manufacturing a beverage bottle utilizing significant amounts of R-PET, comprising:
a first extruder for blending colored R-PET flakes with substantially clear PET flakes to form blended flakes having substantially homogenous color;
a weigh scale blender for measuring pure color;
a pump for dosing the blended flakes with pure color;
a pelletizer for pelletizing the blended flakes;
a second extruder for combining the pelletized blended flakes with V-PET to form the perform, the preform being at least about ten percent (10%) by weight pelletized flakes; and
a blower for shaping the preform into the beverage bottle.

65. The system of claim 64, wherein the second extruder forms the preform, the preform being about twenty percent (20%) by weight palletized flakes.

66. The system of claim 65, the first extruder being adapted to blend the colored R-PET flakes with the substantially clear PET flakes to form the blended flakes, the blended flakes being about seventy-percent (70%) by weight the colored R-PET flakes.

67. The system of claim 64, comprising a shredder for forming colored R-PET flakes from colored beverage bottles and for forming substantially clear R-PET flakes from substantially clear beverage bottles.

68. The system of claim 64, comprising a dryer for drying at least one of the blended flakes and the pelletized flakes.

69. The system of claim 68, wherein the dryer comprises:
a first chamber for drying the pelletized flakes, thereby transferring pellet moisture to the chamber air;
a second chamber for vacuum evacuation of the moist chamber air; and
a third chamber for storing the pelletized flakes in a vacuum condition.

70. The system of claim 64, wherein the first extruder comprises a twin screw extruder having co- and contra-rotation, ring extruders

71. The system of claim 64, wherein the pelletizer comprises a strand-cut pelletizer.

72. The system of claim 64, wherein the first extruder and the pelletizer form an integrated machine.

73. The system of claim 72, wherein the first extruder comprises a twin screw extruder having co- and contra-rotation, ring extruders

74. The system of claim 72, wherein the pelletizer comprises a strand-cut pelletizer

75. The system of claim 64, wherein the pump comprises a peristaltic pump.

76. The system of claim 64, wherein the pump doses the blended flakes with pure color to implement a color depth correction.

77. A system for manufacturing a beverage bottle utilizing significant amounts of R-PET, comprising:
a shredder for forming colored R-PET flakes from colored beverage bottles and for forming substantially clear R-PET flakes from substantially clear beverage bottles;
a first extruder for blending colored R-PET flakes with substantially clear PET flakes to form blended flakes having substantially homogenous color and being about seventy-percent (70%) by weight the colored R-PET flakes.;
a weigh scale blender for measuring pure color;
a peristaltic pump for dosing the blended flakes with pure color;
a pelletizer for pelletizing the blended flakes;
a dryer for drying at least one of the pelletized flakes comprising:
a first chamber for drying the pelletized flakes, thereby transferring pellet moisture to the chamber air;
a second chamber for vacuum evacuation of the moist chamber air; and
a third chamber for storing the pelletized flakes in a vacuum condition;
a second extruder for combining the pelletized blended flakes with V-PET to form the perform, the preform being about twenty percent (20%) by weight pelletized flakes; and
a blower for shaping the preform into the beverage bottle.

78. The system of claim 77, wherein the first extruder comprises a twin screw extruder having co- and contra-rotation, ring extruders

79. The system of claim 77, wherein the pelletizer comprises a strand-cut pelletizer.

80. The system of claim 77, wherein the pump doses the blended flakes with pure color to implement a color depth correction.
